(19) United States
(12) Patent Application Publication
(10) Pub. No.: US 2003/0117010 A1
(43) Pub. Date: Jun. 26, 2003

(54) System and method for dynamic rear brake proportioning

(75) Inventor: Kevin A. O'Dea, Ann Arbor, MI (US)

Correspondence Address: DELPHI TECHNOLOGIES, INC., Legal Staff, Mail Code: 482-204-450, 1450 W. Long Lake, P.O. BOX 5052, Troy, MI, 48098, US

(73) Assignee: DELPHI TECHNOLOGIES INC.

(21) Appl. No.: 10/026,033

(22) Filed: Dec. 21, 2001

(51) Int. Cl. B60T 13/74

(52) U.S. Cl. 303/3; 303/11

(57) ABSTRACT

A brake circuit comprises a master cylinder in communication with a front wheel brake, and in communication with a rear wheel brake through a hydraulic line. A sensor senses pressure in the master cylinder, and an electronic control unit in communication with the sensor controls an apply valve to proportion pressure between the front wheel brake and the rear wheel brake.

### TECHNICAL FIELD OF THE INVENTION

This invention relates generally to braking systems for motor vehicles, and more specifically to a system and method for proportioning braking between front and rear wheels.

### BACKGROUND OF THE INVENTION

Hydraulic circuits form the basis for most vehicle braking systems, especially automotive vehicle braking systems. Hydraulic power is particularly suited to such braking systems since it converts fluid pressure into mechanical motion and allows the source of the hydraulic pressure to be positioned remotely from the cylinders which effect the braking action. Such automotive braking systems are generally hydraulic throughout, consisting of an actuator, such as a brake pedal, a reservoir of fluid such as a master cylinder, whose pressure is responsive to pressure applied by the actuator, and means for converting the hydraulic pressure to braking force, such as brake cylinders. In standard systems of this type, braking pressure is achieved mechanically, utilizing the force of the depression of the brake pedal by the driver (usually accompanied by a vacuum boost) to increase the fluid pressure in the master cylinder, which is then transmitted through fluid lines to the cylinders which operate calipers or shoes, thereby forcing the calipers or shoes against the rotors or drums, respectively, to effect braking action.

Antilock braking systems (ABS) are frequently incorporated into vehicle hydraulic braking systems, such as the aforementioned system, in order to prevent vehicle skidding during “panic” braking events or on wet or snow-covered pavement. Vehicle skidding is undesirable in that the vehicle stopping distance can be lengthened and vehicle control is reduced. In a typical ABS, a wheel speed sensor senses when individual wheels on a vehicle begin to cease rotation or “lock-up” during braking, which is an indication that those vehicle wheels are skidding. Accordingly, in order to minimize such skidding, the ABS modulates hydraulic fluid flow to the locked wheel brake cylinder, thereby causing the brake to cycle between apply and release modes.

The modulation of hydraulic fluid flow to a locking wheel brake prevents wheel lock-up while continuing to apply braking pressure, thereby allowing the driver of the associated vehicle to stop the vehicle in a safer, more controlled manner.

The modulation of fluid flow to the wheel brake cylinders can be accomplished in a variety of ways, but in standard motor-based ABS the hydraulic fluid modulation is effected by the controlled manipulation of ABS apply and release valves upstream of the brake cylinder with the assistance of hydraulic fluid pumps. The apply and release valves are positioned in a bypass loop and are operated such that when an ABS braking event is detected at one of the wheels, pressure initially is bled from the wheels back to the master cylinder until wheel lock-up is overcome. Then, as additional braking force is needed, the apply and release valves “pulse,” thereby providing braking force to the wheel as desired while preventing wheel lock-up and undesirable skidding. Accordingly, in this manner hydraulic fluid pressure is modulated until the vehicle reaches an acceptably safe speed, such as 5 kph. At this time, in order to return braking control to the driver, the ABS release valves are closed and the apply valves are pulsed, thereby gradually restoring full master cylinder output to the wheel brakes.

### SUMMARY OF THE INVENTION

The present invention is a brake circuit comprising a master cylinder in communication with a front wheel brake, and in communication with a rear wheel brake through a hydraulic line. A sensor senses pressure in the master cylinder, and an electronic control unit in communication with the sensor controls an apply valve to proportion pressure between the front wheel brake and the rear wheel brake.

Accordingly, it is an object of the present invention is to provide a brake circuit of the type described above that proportions wheel brake pressure according to pressure in the master cylinder.

Another object of the present invention is to provide a brake circuit of the type described above that proportions wheel brake pressure in the absence of wheel speed information.

Still another object of the present invention is to provide a method of proportioning wheel brake pressure according to master cylinder pressure.

These and other features and advantages of the invention are apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWING

FIG. 1 is a schematic view of a diagonal split braking system according to the present invention.

### DETAILED DESCRIPTION OF THE PRESENTLY PREFERRED EMBODIMENTS

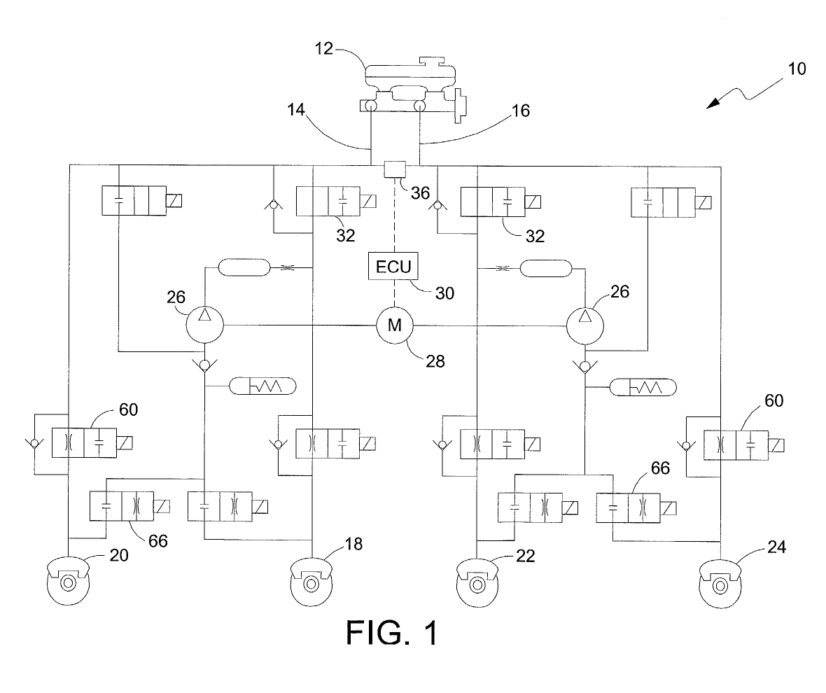

FIG. 1 shows a vehicle brake control system 10 according to the present invention. The brake control system 10 includes a conventional master cylinder 12 that is operable to produce a pressure in passages 14 and 16 when the operator depresses the vehicle brake pedal. The passages 14 and 16 supply pressurized fluid to separate, substantially identical circuits. The system 10 is a diagonal split in which each of the two brake circuits controls wheels on diagonally opposite sides of the vehicle. For example, one circuit controls the right front wheel brake 18 and the left rear wheel brake 20, and the other circuit controls the left front wheel brake 22 and the right rear wheel brake 24. It should be appreciated, of course, that the present invention is equally applicable in a front/rear split braking configuration. The brake control system 10 also includes positive displacement pumps 26 that are driven by an electric motor 28. An electronic control unit (ECU) 30 controls the speed of the motor 28, and accordingly controls the output volume of the pumps 26.

The passages 14 and 16 are each in fluid communication with an isolation valve 32 and a master cylinder pressure sensor 36. The valves 32 are either solenoid controlled linear valves or two-position directional valves that are normally open to connect the passages 14 and 16 with the front wheel brakes. During normal braking, linear solenoid apply valves 60 at each of the rear wheels are open to communicate braking pressure to the rear wheel brakes. Normally closed release valves 66 are closed at this time. When the operator applies the brakes, but sensors such as wheel speed sensors indicate skidding to the ECU, any of the apply valves 60 can be independently closed and its corresponding release valve can be opened. To reapply the wheel brake, such as during an ABS event, any of the apply valves 60 is opened and its associated release valve is closed.

In the event of failure of the wheel speed sensors, or in their absence from the circuit altogether, the present invention provides a method for dynamic proportioning between the front and rear wheel brakes according to any known algorithm. The master cylinder pressure sensor 36 communicates the pressure in the master cylinder 12 to the ECU 30. Based on the master cylinder pressure, the ECU 30 controls the pressure developed at each of the wheel brakes. In particular, the ECU commands a voltage to the linear apply valves 60 proportional to the rear braking pressure necessary to achieve the desired proportioning between the front brakes 18 and 22 and the rear brakes 20 and 24.

In additional to being applicable in the absence of wheel speed information, the present invention can be implemented as part of a strategy where the master cylinder pressure and the wheel speed information are both used as inputs to determine rear brake proportioning. While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A brake circuit comprising:
a front wheel brake;
a rear wheel brake;
a master cylinder in communication with the front wheel brake, and in communication with the rear wheel brake through a hydraulic line;
a sensor for sensing pressure in the master cylinder;
an apply valve in the hydraulic line; and
an electronic control unit in communication with the sensor and with the apply valve, the electronic control unit controlling the apply valve to proportion pressure between the front wheel brake and the rear wheel brake.

2. The brake circuit of claim 1 wherein the apply valve is a linear solenoid valve.

3. The brake circuit of claim 1 wherein the brake circuit is a diagonal split.

4. A method of proportioning pressure between a front wheel brake and a rear wheel brake, the method comprising:
providing a master cylinder in communication with the front wheel brake, and in communication with the rear wheel brake through a hydraulic line;
sensing pressure in the master cylinder;
providing an apply valve in the hydraulic line; and
controlling the apply valve to proportion pressure between the front wheel brake and the rear wheel brake based on the pressure in the master cylinder.

5. The method of claim 4 wherein the controlling step is performed by an electronic control unit.

6. The method of claim 4 wherein the apply valve is a linear solenoid valve.

7. The method of claim 4 wherein the brake circuit is a diagonal split.
